(19) United States
(12) Patent Application Publication
(10) Pub. No.: US 2021/0070130 A1
(43) Pub. Date: Mar. 11, 2021

(54) SHOCK ABSORBER FOR VEHICLE

(71) Applicant: MANDO CORPORATION, Gyeonggi-do (KR)

(72) Inventor: Moonsang CHEONG, Jeollabuk-do (KR)

(21) Appl. No.: 17/018,700

(22) Filed: Sep. 11, 2020

(30) Foreign Application Priority Data
Sep. 11, 2019 (KR) 10-2019-0112575

(51) Int. Cl. B60G 17/08; F16F 13/00; F16F 9/32; F16F 9/36; F16F 9/34; F16F 9/18; B60G 15/06; F16F 9/346; F16F 9/48; F16F 9/516; F16F 9/19

(52) U.S. Cl. CPC B60G 17/08; F16F 13/007; F16F 9/3235; F16F 9/368; F16F 9/3405; F16F 9/185; F16F 9/348; F16F 9/346; F16F 9/483; F16F 9/516; F16F 9/19; B60G 2202/24; B60G 2500/11; B60G 15/061

(57) ABSTRACT

Disclosed is a shock absorber for a vehicle including a cylinder filled with a fluid, a piston rod disposed inside the cylinder, a piston valve disposed at a lower portion of the piston rod, a stopper installed above the piston valve on the piston rod, a free piston configured to divide the cylinder into a first chamber and a second chamber below the first chamber and installed on the piston rod to be movable upward from the stopper, a spring configured to elastically support the free piston, and a bypass portion provided on an inner circumferential surface of the cylinder.

### CROSS-REFERENCE TO RELATED APPLICATION(S)

This application is based on and claims priority under 35 U.S.C. § 119 to Korean Patent Application No. 10-2019-0112575, filed on Sep. 11, 2019, in the Korean Intellectual Property Office, the disclosure of which is incorporated by reference herein in its entirety.

### BACKGROUND

### 1. Field

The disclosure relates to a field of shock absorption for a vehicle, and more particularly, to a shock absorber for a vehicle having a soft changing characteristic of a damping force during a compression stroke or a rebound stroke.

### 2. Description of the Related Art

In general, a shock absorber is installed in a transportation means such as a vehicle to absorb and relieve vibrations or shocks applied from a road surface during driving to improve ride comfort. There are two types of shock absorbers, solid friction type and hydraulic type, depending on the configuration and implementation method, and most of the shock absorbers are hydraulic type. The shock absorber typically includes a cylinder and a piston rod installed to perform compression and rebound strokes in the cylinder. The cylinder and the piston rod are each coupled to a vehicle body, wheels, or vehicle axles.

In order to improve the ride comfort or steering stability of a vehicle according to a road surface condition or a driving condition, many studies have been conducted on the damping force characteristics of such a shock absorber.

Korean Registered Patent Publication No. 10-1094214 has been disclosed as an example of a conventional shock absorber for a vehicle.

### SUMMARY

It is an aspect of the disclosure to provide a shock absorber for a vehicle having a soft changing characteristic of a damping force during a compression stroke or a rebound stroke.

It is another aspect of the disclosure to provide a shock absorber for a vehicle capable of gradually increasing or decreasing a damping force without rapidly changing the damping force during a compression stroke or a rebound stroke.

It is another aspect of the disclosure to provide a shock absorber for a vehicle capable of preventing excessive movement of a vehicle body by properly absorbing vibrations generated during driving of the vehicle.

Additional aspects of the disclosure will be set forth in part in the description which follows and, in part, will be obvious from the description, or may be learned by practice of the disclosure.

In accordance with an aspect of the disclosure, a shock absorber for a vehicle includes a cylinder filled with a fluid, a piston rod disposed inside the cylinder, a piston valve disposed at a lower portion of the piston rod, a stopper installed above the piston valve on the piston rod, a free piston configured to divide the cylinder into a first chamber and a second chamber below the first chamber and installed on the piston rod to be movable upward from the stopper, a spring configured to elastically support the free piston, and a bypass portion provided on an inner circumferential surface of the cylinder.

The bypass portion may be formed in a groove shape recessed from the inner circumferential surface of the cylinder in an outer diameter direction thereof.

A plurality of the bypass portions extending in a vertical direction based on an axial direction of the piston rod may be provided.

The plurality of bypass portions may be provided such that lower end portions thereof are disposed in the first chamber.

The plurality of bypass portions may be provided such that upper end portions thereof are disposed in the second chamber, and the free piston may be fixedly coupled to the piston rod.

The shock absorber may further include a seal member provided on an outer circumferential surface of the free piston to seal a gap between the free piston and the inner circumferential surface of the cylinder.

The seal member may be formed in a ring shape to be fitted along a seal groove formed on the outer circumferential surface of the free piston.

A gap may be formed between the free piston and the piston rod to form a gap passage communicating the first chamber and the second chamber.

The stopper may include a seat portion made of an elastic material to buffer an impact upon contact with a lower end of the free piston.

In accordance with another aspect of the disclosure, a shock absorber for a vehicle includes a cylinder filled with a fluid and including an inner tube and an outer tube disposed outside the inner tube, a piston rod disposed inside the inner tube, a piston valve disposed at a lower portion of the piston rod, a stopper installed above the piston valve on the piston rod, a free piston configured to divide the inner tube into a first chamber and a second chamber below the first chamber and movably installed on the piston rod, a spring configured to elastically support the free piston, and a bypass portion provided on an inner circumferential surface of the inner tube, wherein the bypass portion forms a path through which the fluid is bypassed between the first chamber and the second chamber when the free piston passes through the bypass portion during a rebound stroke of the piston rod.

The shock absorber may further include a stopper installed above the piston valve on the piston rod, wherein the free piston may be installed on the piston rod to be movable upward from the stopper.

The stopper may be provided with a small diameter portion and a large diameter portion, and the large diameter portion may be in contact with a lower portion of the free piston during the rebound stroke of the piston rod.

The piston valve may be provided with a plurality of disks at upper and lower portions thereof, respectively.

The free piston may be provided with a movement groove recessed from an upper surface of the free piston toward a lower side thereof, and a space through which the fluid moves may be formed between the free piston and the spring.

The bypass portion may be formed in a groove shape recessed from the inner circumferential surface of the inner tube in an outer diameter direction thereof.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view of a shock absorber for a vehicle according to an embodiment of the disclosure;

FIGS. 2 and 3 are operational views the shock absorber for a vehicle according to an embodiment of the disclosure; and

FIG. 4 is a graph showing a variable damping force during a rebound stroke according to an embodiment of the disclosure.

### DETAILED DESCRIPTION

Hereinafter embodiments of the disclosure will be described in detail with reference to the accompanying drawings. The embodiments described below are provided by way of example so that those skilled in the art will be able to fully understand the spirit of the disclosure. The disclosure is not limited to the embodiments described below, but may be embodied in other forms. In order to clearly explain the disclosure, parts not related to the description are omitted from the drawings, and the width, length, thickness, etc. of the components may be exaggerated for convenience.

A shock absorber for a vehicle according to an embodiment of the disclosure may include a cylinder 10 filled with a fluid, a piston rod 20 disposed inside the cylinder 10, a piston valve 30 disposed at a lower portion of the piston rod 20, a stopper 40 installed at the top of the piston valve 30 on the piston rod 20, a free piston 50 configured to divide the cylinder 10 into a first chamber 15 and a second chamber 16 below the first chamber 15 and installed on the piston rod 20 to be movable upward from the stopper 40, a spring 60 configured to elastically support the free piston 50, and a bypass portion 70 provided on an inner circumferential surface of the cylinder 10. The bypass portion 70 may form a path through which a fluid is bypassed between the first chamber 15 and the second chamber 16 when the free piston 50 is located on the bypass portion 70.

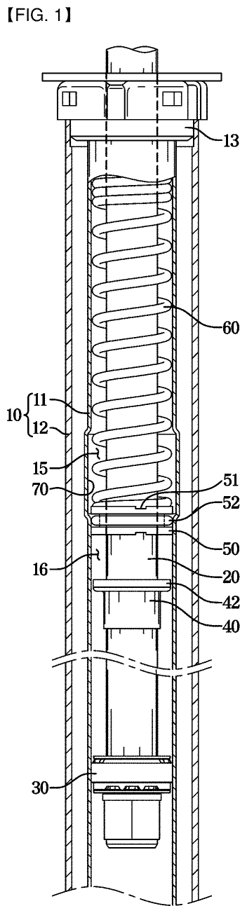

As illustrated in FIG. 1, the shock absorber for a vehicle according to an embodiment of the disclosure is provided with the cylinder 10 filled with a working fluid such as oil. As illustrated in FIGS. 1 to 3, the cylinder 10 is composed of an inner tube 11 forming a space therein and an outer tube 12 disposed outside the inner tube 11. The inner tube 11 may have a cylindrical shape forming a space therein, and a fluid (oil, etc.) is filled inside the inner tube 11. The outer tube 12 has a larger diameter than an outer diameter of the inner tube 11 and may be formed in a shape corresponding to the inner tube 11. A storage space in which a fluid may be filled may be formed between the inner tube 11 and the outer tube 12. The inside of the inner tube 11 may be divided into the first chamber 15 and the second chamber 16 by the free piston 50, which will be described later. The inner tube 11 and the outer tube 12 of the cylinder 10 may be connected by a body valve (not shown). Therefore, when the piston rod 20, which will be described later, performs a compression stroke, the fluid in the storage space between the inner tube 11 and the outer tube 12 may be moved into the inner tube 11. Also, when the piston rod 20 performs a rebound stroke, the fluid inside the inner tube 11 may be moved into the storage space between the inner tube 11 and the outer tube 12. One end of the cylinder 10 and one end of the piston rod 20, which will be described later, may perform the compression or rebound stroke in a state of being connected to the vehicle body or the vehicle, respectively. FIGS. 1 to 3 illustrate that the cylinder 10 is composed of the inner tube 11 and the outer tube 12, but is not limited thereto, and the cylinder 10 may be composed of only a single tube such as a mono tube.

The piston rod 20 is disposed inside the cylinder 10 and may slide during the compression stroke or the rebound stroke. The piston rod 20 may be disposed inside the inner tube 11 of the cylinder 10. Specifically, the piston rod 20 may slide downward in the cylinder 10 during the compression stroke and may slide upward in the cylinder 10 during the rebound stroke. The piston valve 30 may be disposed at the lower portion of the piston rod 20. The piston valve 30 may be provided with a plurality of disks at upper and lower portions thereof to generate a damping force due to a resistance force of the fluid during the compression or rebound stroke.

The stopper 40 is installed on the piston rod 20 and may be disposed above the piston valve 30. The stopper 40 is configured to prevent direct collision between the piston valve 30 and the free piston 50, which will be described later, during the rebound stroke.

The stopper 40 may be provided with a small diameter portion and a large diameter portion. The small diameter portion of the stopper 40 has a diameter smaller than the diameter of the inner tube 11, and the large diameter portion of the stopper 40 has a larger diameter than the small diameter portion. As illustrated in the figure, the stopper 40 may be installed on the piston rod 20 such that the large diameter portion and the small diameter portion are disposed upward and downward on the piston rod 20, respectively. The large diameter portion of the stopper 40 may be in contact with a lower portion of the free piston 50 during the rebound stroke of the piston rod 20. A seat portion 42 may be coupled to an upper surface of the large diameter portion of the stopper 40.

The free piston 50 is installed movably on the piston rod 20. More specifically, the free piston 50 may be installed on the piston rod 20 to be movable upward from the stopper 40. The free piston 50 divides the cylinder 10 into the first chamber 15 and the second chamber 16, and thus the first chamber 15 is formed above the free piston 50 inside the cylinder 10, and the second chamber 16 is formed below the free piston 50 inside the cylinder 10.

As illustrated in FIG. 1, the spring 60 has one end connected to the free piston 50 and the other end connected to a rod guide 13 of the cylinder 10. During the rebound stroke of the piston rod 20, the stopper 40 moves upward, and when the stopper 40 presses the free piston 50, a damping force is generated with an elastic force of the spring 60 added. Therefore, the damping force may rapidly increase from a section in which the elastic force of the spring 60 is added.

The bypass portion 70 is formed on the inner circumferential surface of the cylinder 10. FIGS. 1 to 3 illustrate that the bypass portion 70 is formed on an inner circumferential surface of the inner tube 11, but when the cylinder 10 is provided as a mono tube, the bypass portion 70 may be formed on an inner circumferential surface of the mono tube. The bypass portion 70 may form a path through which a fluid is bypassed between the first chamber 15 and the second chamber 16 when the free piston 50 is located inside the bypass portion 70. Therefore, when the free piston 50 presses the spring 60 by the stopper 40, a path through which the fluid is bypassed from the first chamber 15 to the second chamber 16 is formed, so that the damping force may increase smoothly without increasing rapidly. More specifically, the bypass portion 70 may form a path through which the fluid is bypassed between the first chamber 15 and the second chamber 16 when the piston rod 20 slides upward during the rebound stroke of the piston rod 20 so that the free piston 50 passes through the bypass portion 70.

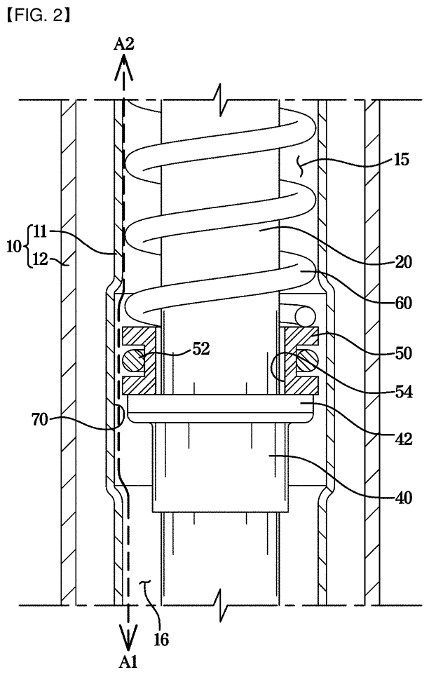

More specifically, the bypass portion 70 may be formed in a groove shape that is recessed from the inner circumferential surface of the cylinder 10 in an outer radial direction. That is, the bypass portion 70 may be formed in a groove shape that is recessed from the inner circumferential surface of the inner tube 11 in an outer diameter direction thereof. Therefore, when the free piston 50 is located inside the bypass portion 70 as illustrated in FIG. 2, the fluid may be bypassed between the first chamber 15 and the second chamber 16 through the recessed bypass portion 70 (path “A1” or “A2” in FIG. 2).

A plurality of the bypass portions 70 may be provided and may extend in a vertical direction based on an axial direction of the piston rod 20. The plurality of bypass portions 70 may be disposed to be spaced apart from each other along a circumferential direction of the cylinder 10.

The plurality of bypass portions 70 may be provided such that a lower end thereof is disposed in the first chamber 15. As described above, the bypass portions 70 may extend in the vertical direction based on the axial direction of the piston rod 20. Accordingly, the free piston 50 may be disposed below the bypass portions 70 based on the axial direction of the piston rod 20. In this case, the free piston 50 may be located inside the bypass portions 70 while moving upward during the rebound stroke. In order to allow a lower end portion of the bypass portion 70 to be located in the first chamber 15, a length of the spring 60 may be adjusted. In the above case, the change in damping force during the rebound stroke may be further gentle.

The plurality of bypass portions 70 may be provided such that an upper end portion thereof is disposed in the second chamber 16, and the free piston 50 may be fixedly coupled to the piston rod 20. As described above, the bypass portions 70 may extend in the vertical direction based on the axial direction of the piston rod 20. Accordingly, the free piston 50 may be disposed above the bypass portions 70 based on the axial direction of the piston rod 20. In this case, the free piston 50 may be located inside the bypass portions 70 while moving downward together with the piston rod 20 during the compression stroke. In order to allow the upper end portion of the bypass portion 70 to be located in the second chamber 15, the length of the spring 60 may be adjusted. In the above case, the change in damping force during the compression stroke may be further gentle.

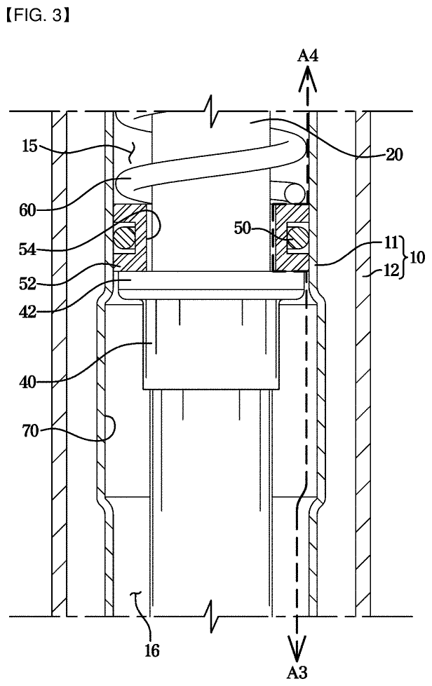

The shock absorber for a vehicle according to an embodiment of the disclosure may further include a seal member 52 provided on an outer circumferential surface of the free piston 50 to seal a gap between the free piston 50 and the inner circumferential surface of the cylinder 10. Therefore, when the free piston 50 is not located inside the bypass portion 70 as illustrated in FIG. 3, the movement of fluid between the outer circumferential surface of the free piston 50 and the cylinder 10 may be prevented.

Specifically, the seal member 52 may be formed in a ring shape to be fitted along a seal groove formed on the outer circumferential surface of the free piston 50. The seal member 52 may be made of an elastic material such as rubber.

A movement groove 51 may be provided on the free piston 50. More specifically, the movement groove 51 of the free piston 50 may be formed in a groove shape that is recessed from an upper surface of the free piston 50 toward a lower side. As the movement groove 51 is provided, a gap (movement groove) is formed between the free piston 50 and the spring 60 even when the spring 60 is coupled to or installed on an upper portion of the free piston 50 so that the fluid may move through the movement groove 51. A plurality of the moving grooves 51 may be provided to be spaced apart from each other along a circumferential direction on the upper surface of the free piston 50.

A gap may be formed between the free piston 50 and the piston rod 20 to form a gap passage 54 communicating the first chamber 15 and the second chamber 16. Therefore, when the piston rod 20 performs the compression stroke or the rebound stroke, the fluid may move between the first chamber 15 and the second chamber 16 through the gap passage 54 (path “A3” or “A4” in FIG. 3). Also, a rate of fluid movement may be regulated by adjusting a width (or length) of the gap formed between the free piston 50 and the piston rod 20.

The stopper 40 may include the seat portion 42 made of an elastic material to buffer an impact upon contact with a lower end of the free piston 50. The seat portion 42 may be made of an elastic material such as rubber, and prevents the stopper 40 and the free piston 50 from colliding directly during the rebound stroke of the piston rod 20 so that breakage of the stopper 40 and the free piston 50 may be prevented.

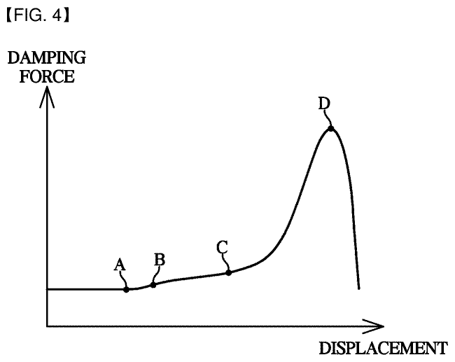

Hereinafter, an operation of the shock absorber for a vehicle during the rebound stroke will be described with reference to FIGS. 2 to 4. FIG. 4 is a graph showing a variable damping force during a rebound stroke according to an embodiment of the disclosure. In FIG. 4, a horizontal axis indicates a change in displacement due to sliding of the piston rod, and a vertical axis indicates a change in damping force.

In the case of the rebound stroke, the piston rod 20 may be moved upward in the inside of the cylinder 10 during the rebound stroke. Also, the stopper 40 installed on the piston rod 20 is moved upward together. At this time, the fluid moves through a passage formed in the piston valve 30, and the damping force increases to a certain magnitude (slopes of “A” and “B” in FIG. 4). Thereafter, when the stopper 40 presses the free piston 50, an elastic force is added to the damping force (slopes of “B” and “C” in FIG. 4). At this time, the free piston 50 is located inside the bypass portion 70 to form a bypass path through which the fluid may pass, so that the damping force may gently increase. When the free piston 50 completely passes through the bypass portion 70, the elastic force of the spring 60 and the resistance force of the fluid are wholly applied to the free piston 50, and the fluid may only move through the gap passage 54. Therefore, the damping force rapidly increase (slopes of “C” and “D” in FIG. 4).

The position of a point “A” in FIG. 4 may be set by adjusting the position of the free piston to adjust the length of the spring, the positions of points “B” and “C” may be set by adjusting a spring constant or by adjusting a length or size of the bypass portion, and the position of a point “D” may be set by a cross-sectional area or a total size of the free piston or a size (or width) of the gap passage. Also, the compression stroke may be operated in the reverse order of the rebound stroke.

As is apparent from the above, a shock absorber for a vehicle according to an embodiment of the disclosure can smoothly change a damping force caused by an operation of a piston rod.

Further, the shock absorber for a vehicle according to an embodiment of the disclosure can easily adjust the damping force characteristic by adjusting a length of a spring.

While the disclosure has been particularly described with reference to exemplary embodiments, it should be understood by those of skilled in the art that various changes in form and details may be made without departing from the spirit and scope of the disclosure.

What is claimed is:

1. A shock absorber for a vehicle comprising:
a cylinder filled with a fluid;
a piston rod disposed inside the cylinder;
a piston valve disposed at a lower portion of the piston rod;
a stopper installed above the piston valve on the piston rod;
a free piston configured to divide the cylinder into a first chamber and a second chamber below the first chamber and installed on the piston rod to be movable upward from the stopper;
a spring configured to elastically support the free piston; and
a bypass portion provided on an inner circumferential surface of the cylinder,
wherein the bypass portion forms a path through which the fluid is bypassed between the first chamber and the second chamber when the free piston is located in the bypass portion.

2. The shock absorber according to claim 1, wherein
the bypass portion is formed in a groove shape recessed from the inner circumferential surface of the cylinder in an outer diameter direction thereof.

3. The shock absorber according to claim 2, wherein
a plurality of the bypass portions extending in a vertical direction based on an axial direction of the piston rod is provided.

4. The shock absorber according to claim 3, wherein
the plurality of bypass portions is provided such that lower end portions thereof are disposed in the first chamber.

5. The shock absorber according to claim 3, wherein
the plurality of bypass portions is provided such that upper end portions thereof are disposed in the second chamber, and
the free piston is fixedly coupled to the piston rod.

6. The shock absorber according to claim 1, further comprising
a seal member provided on an outer circumferential surface of the free piston to seal a gap between the free piston and the inner circumferential surface of the cylinder.

7. The shock absorber according to claim 6, wherein
the seal member is formed in a ring shape to be fitted along a seal groove formed on the outer circumferential surface of the free piston.

8. The shock absorber according to claim 1, wherein
a gap is formed between the free piston and the piston rod to form a gap passage communicating the first chamber and the second chamber.

9. The shock absorber according to claim 1, wherein
the stopper comprises a seat portion made of an elastic material to buffer an impact upon contact with a lower end of the free piston.

10. A shock absorber for a vehicle comprising:
a cylinder filled with a fluid and comprising an inner tube and an outer tube disposed outside the inner tube;
a piston rod disposed inside the inner tube;
a piston valve disposed at a lower portion of the piston rod;
a stopper installed above the piston valve on the piston rod;
a free piston configured to divide the inner tube into a first chamber and a second chamber below the first chamber and movably installed on the piston rod;
a spring configured to elastically support the free piston; and
a bypass portion provided on an inner circumferential surface of the inner tube,
wherein the bypass portion forms a path through which the fluid is bypassed between the first chamber and the second chamber when the free piston passes through the bypass portion during a rebound stroke of the piston rod.

11. The shock absorber according to claim 10, further comprising
a stopper installed above the piston valve on the piston rod,
wherein the free piston is installed on the piston rod to be movable upward from the stopper.

12. The shock absorber according to claim 11, wherein
the stopper is provided with a small diameter portion and a large diameter portion, and
the large diameter portion is in contact with a lower portion of the free piston during the rebound stroke of the piston rod.

13. The shock absorber according to claim 10, wherein
the piston valve is provided with a plurality of disks at upper and lower portions thereof, respectively.

14. The shock absorber according to claim 10, wherein
the free piston is provided with a movement groove recessed from an upper surface of the free piston toward a lower side thereof, and
a space through which the fluid moves is formed between the free piston and the spring.

15. The shock absorber according to claim 10, wherein
the bypass portion is formed in a groove shape recessed from the inner circumferential surface of the inner tube in an outer diameter direction thereof.
